(19) United States
(12) Patent Application Publication
(10) Pub. No.: US 2005/0280881 A1
(43) Pub. Date: Dec. 22, 2005

(54) System and method for determination of a white point for calibration of an image capturing device

(75) Inventors: Michael Stokes, Eagle, ID (US); Vladimir Sadovsky, Bellevue, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/870,520

(22) Filed: Jun. 18, 2004

(51) Int. Cl. G06F 15/00

(52) U.S. Cl. 358/504; 358/1.9

(57) ABSTRACT

A method and system for easy and accurate calibration and characterization of an image capturing device is provided. Captured spectral calibration target data is received and sensor spectral sensitivities of the image capturing device are obtained. A determination of white point data for calibration of the image capturing device is made. Sensor spectral sensitivities of the image capturing device can be obtained from data from a manufacturer of the image capturing device or automatically by spectral decomposition methods. The white point data also can be determined by spectral decomposition methods. Captured spectral calibration target data can be obtained from a pre-existing standard, such as IEC 61966-8.

### FIELD OF THE INVENTION

Aspects of the present invention are directed generally to calibration and characterization systems of image capturing devices. More particularly, aspects of the present invention are directed to a system and method for white point calibration for image capturing devices.

### BACKGROUND OF THE INVENTION

The human visual system is both sophisticated and adaptable to various conditions. A sheet of white paper looks white under various lighting conditions, such as daylight, fluorescent, and tungsten. However, if one were to take a picture of the sheet of white paper under each of these lighting conditions, the images would all appear to have a different white for the sheet of paper. The human visual system makes continuous adjustments to lighting conditions and shadow affects in order to maintain a consistent white for a target. White point adaptation is an involuntary reaction performed by one's eyes. Incorporating the ability to adapt to various lighting conditions in a digital camera is complex due to the various parameters that must be taken into account.

Easy and accurate calibration and characterization of image capturing devices has become an increasing issue in the field of color management technology. As digital technology has increased, specifically in the areas of digital cameras and scanners, different types and models of image capturing devices have increased as well. Each manufacturer of a digital camera has specific camera sensitivity in each particular model of camera. A sensor sensitivity of one camera model of a first manufacturer is different from a sensor sensitivity for one camera model of a second manufacturer and for a second camera model of the first manufacturer.

Image capturing device calibration has proven to be a difficult obstacle to overcome due to the mismatch between the sensor and hardware capabilities of the image capturing device and the sophistication and adaptability of the human visual system. One specific problem in digital camera calibration relates to the ability to easily and automatically determine the white point of a target that the digital camera is capturing. Historically, determination of a white point has been done by one of two general methods.

Predetermined, fixed white point correction is the first general method. In this case, one attempts to determine a white point in the target and correlates the ratio of captured red/green/blue (RGB) sensor data with known ratios from manufacturing experience for the particular image capturing device. Known ratios from manufacturing experience for the particular image capturing device can be obtained by capture of a white unit under various lighting conditions, including fluorescent, tungsten, and daylight. The fixed white point correction method includes built in errors and limitations. In particular, lighting conditions of one type, such as daylight, are not necessarily the same in a user's house compared to an outdoor environment. Colorimetric matching, such as for paint samples, includes white point correction and is the second general method. For this case, one can use multiple color samples to build a specific spectrum to match a given sample. This method uses spectral decomposition and statistical regression.

Internal limitations of a digital camera restrict the accurate representation of image content due to a failure of proper calibration of the digital camera to an accurate white point. Although one can calibrate a digital camera, the image taken by the digital camera is never properly calibrated to an accurate representation of the target. Therefore, the calibrated camera of today may take pictures for processing that operates according to its calibration; however, the camera may always bias certain or all variables in a certain manner because of the inaccurate calibration. For example, a camera may be calibrated with a less saturated blue color. Any subsequent highly saturated blue color will be lost by the calibration of the camera.

### SUMMARY OF THE INVENTION

There is therefore a need for a white point derivation system that allows for derivation of the white point for easy and accurate calibration of an image capturing device, such as a digital still camera. An aspect of the present invention provides an architecture that receives captured spectral calibration target data, obtains sensor spectral sensitivities of the image capturing device, and determines white point data for calibration of the image capturing device. Captured spectral calibration target data can be obtained from a pre-existing standard, such as IEC 61966-8.

Another aspect of the invention provides for obtaining sensor spectral sensitivities of the image capturing device from data from a manufacturer of the image capturing device or automatically by spectral decomposition methods. Still another aspect of the invention provides for the determination of the white point data by spectral decomposition methods. In addition, the calibration of the white point can be based upon a plurality of lighting conditions of the spectral calibration target.

Another aspect of the invention provides for determining ratios of sensor parameters based upon neutral patch sample data of captured calibration target data, determining ratios of intermediate spectral data based upon captured spectral calibration target data, and eliminating common spectral components of the determined ratios of sensor parameters and determined ratios of intermediate spectral data.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a graphical representation of the spectral response of a fluorescent light source and a tungsten light source;

FIGS. 2A and 2B are graphical representations of measurement parameters for camera sensors;

FIG. 3A illustrates a schematic diagram of a general-purpose digital computing environment in which certain aspects of the present invention may be implemented;

FIGS. 3B through 3M show a general-purpose computer environment supporting one or more aspects of the present invention;

FIGS. 4A and 4B are flowcharts of an illustrative embodiment of the steps to determine a white point according to at least one aspect of the present invention; and

FIG. 5 illustrates a block diagram of an example of a spectral calibration target and spectral responses.

### DETAILED DESCRIPTION OF ILLUSTRATIVE EMBODIMENTS

In the following description of various illustrative embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

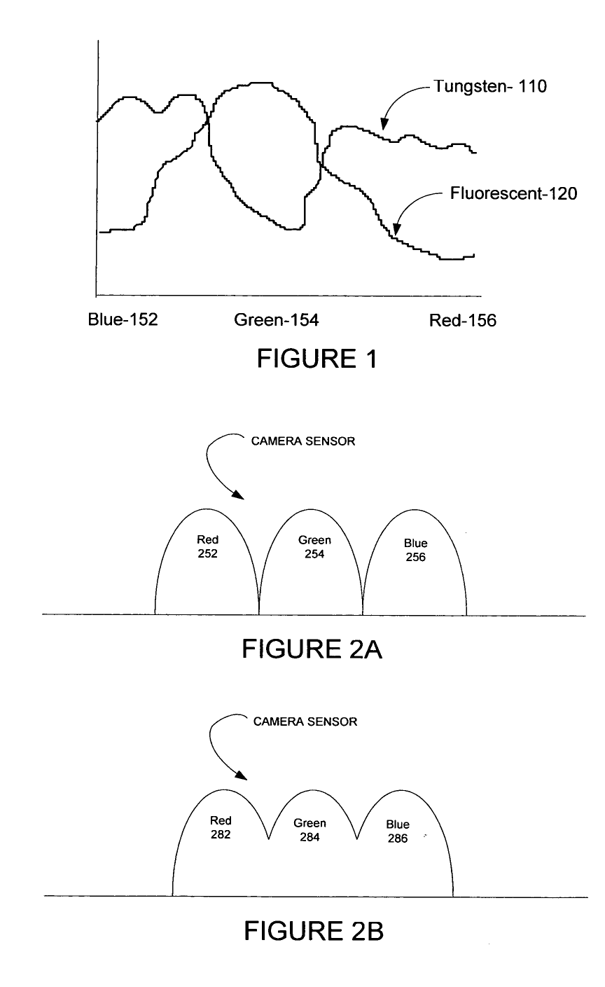

FIG. 1 shows a graphical representation of the spectral response of a fluorescent light source and a tungsten light source. FIG. 1 shows an example of how different light sources have different color data values that make up the spectral response. FIG. 1 shows a spectral response for each of blue 152, green 154, and red 156 data values for a particular light source. As shown in FIG. 1, a tungsten light source has a response 110 that includes a lower green 154 data value in relation to blue 152 and red 156 data values. Alternatively, a fluorescent light source is shown with a response 120 that includes a higher green 154 data value in relation to blue 152 and red 156 data values. There are a variety of different light sources known in the art and it should be appreciated by those skilled in the art that the light source responses shown in FIG. 1 are but two examples. There are many different light source responses beyond those illustrated in FIG. 1 and the present invention is not so limited to those shown in FIG. 1. It should be understood by those skilled in the art that white point is commonly defined by three channels; however, the present invention is not so limited. For example, the present invention may be used with a four channel sensor, such as the 4-color filter charge coupled device (CCD) (red, green, blue and “emerald” sensors) by Sony Corporation of Tokyo, Japan. For purposes of simplicity, the illustrative examples will show a three-channel system.

FIG. 2A is a graphical representation of measurement parameters for an image capturing device sensor, such as a digital camera sensor. FIG. 2A shows an example of a camera sensor with red 252, green 254, and blue 256 parameters. Red 252, green 254, and blue 256 parameters are shown in an example form that is common among digital cameras. As shown in FIG. 2A, red 252, green 254, and blue 256 parameters do not overlap. This type of digital camera sensor is weak in the areas between the parameter areas, such as between red 252 parameter and green 254 parameter and between green 254 parameter and blue 256 parameter.

FIG. 2B is a graphical representation of measurement parameters for an image capturing device sensor, such as a digital camera sensor. FIG. 2B shows an example of a camera sensor with red 282, green 284, and blue 286 parameters. Red 282, green 284, and blue 286 parameters are shown in an example form that is common among digital cameras. As shown in FIG. 2B, red 282, green 284, and blue 286 parameters overlap. This type of digital camera sensor is oversensitive in the areas at the sides of the parameter areas, such as one side of red 282 parameter and one side of green 284 parameter and between a second side of green 284 parameter and one side of blue 286 parameter.

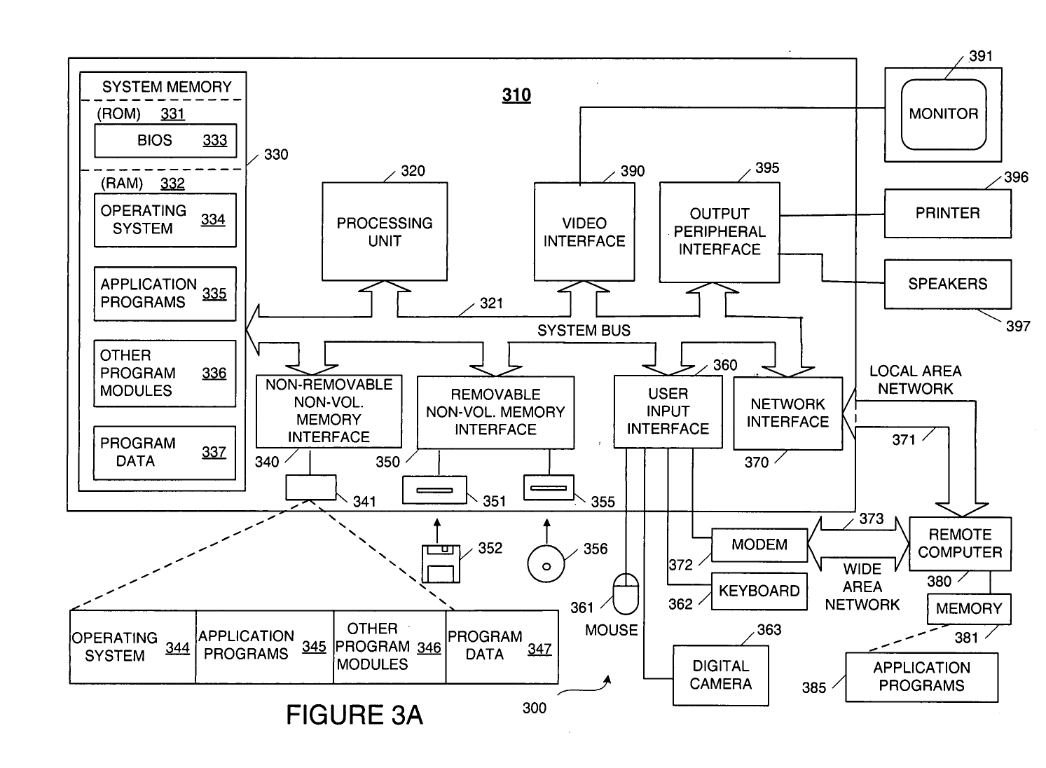

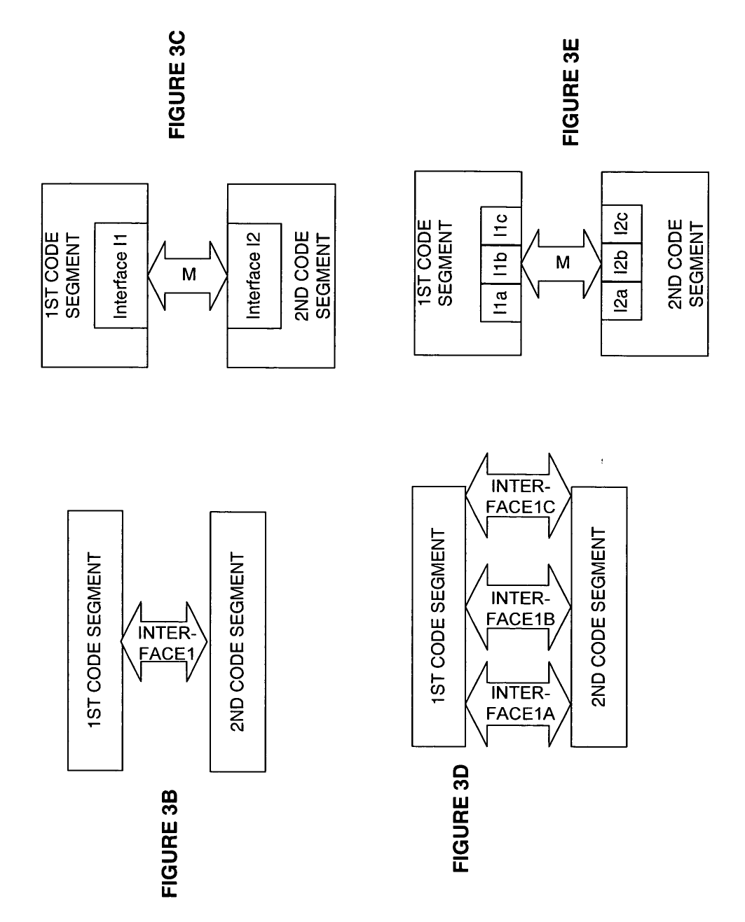

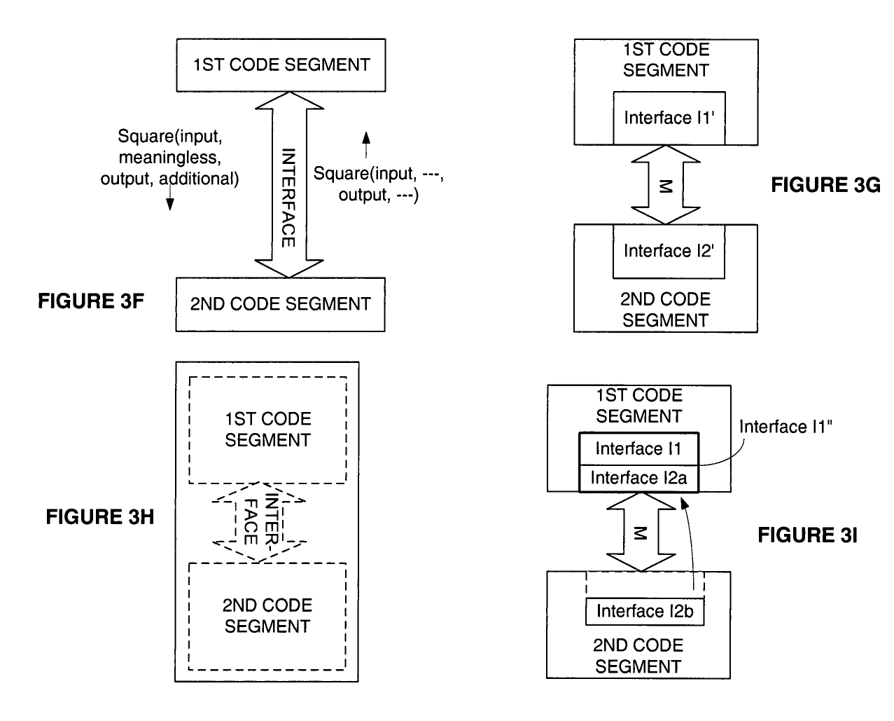

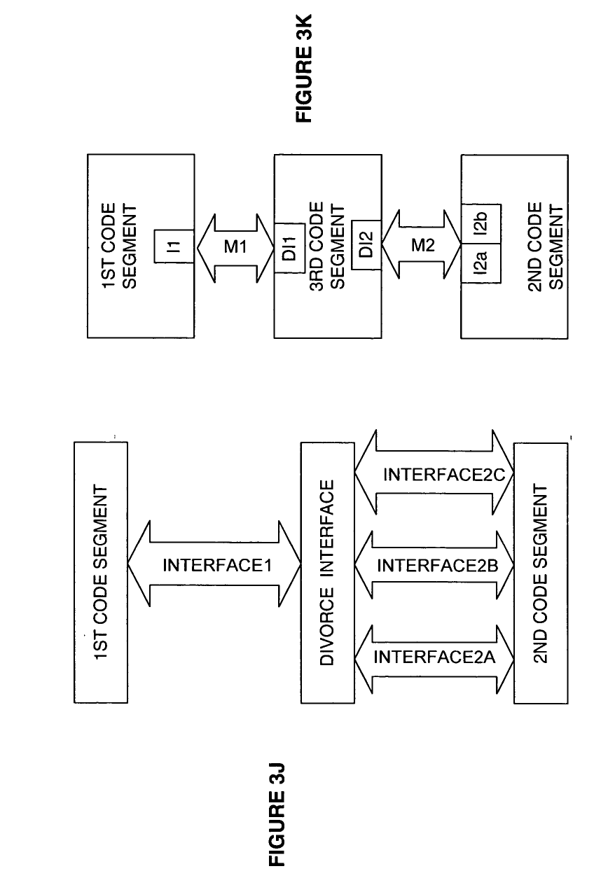

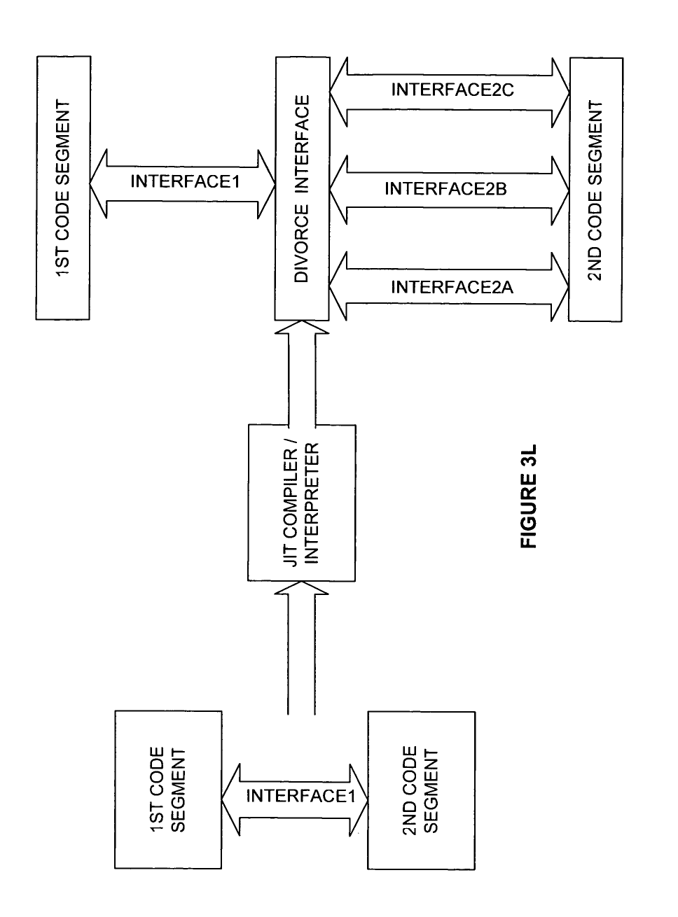

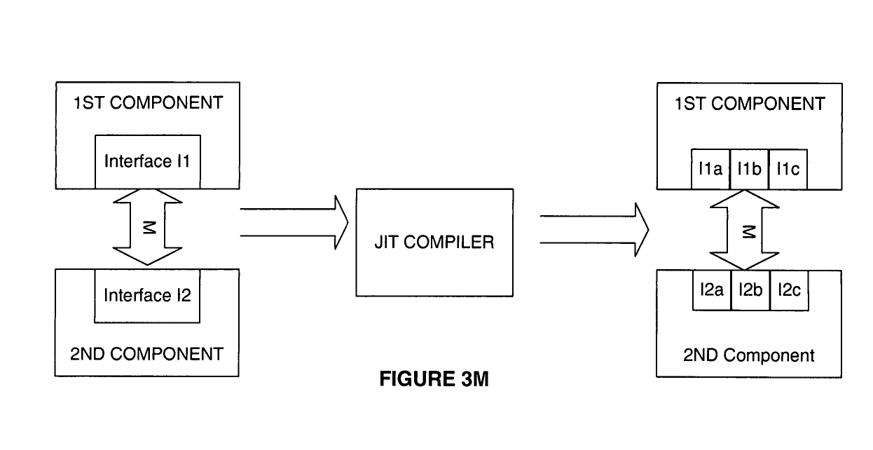

FIG. 3 illustrates an example of a suitable computing system environment 300 on which the invention may be implemented. The computing system environment 300 is only one example of a suitable computing environment and is not intended to suggest any limitation as to the scope of use or functionality of the invention. Neither should the computing system environment 300 be interpreted as having any dependency or requirement relating to any one or combination of components illustrated in the exemplary computing system environment 300.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 3A, an exemplary system for implementing the invention includes a general-purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as ROM 331 and RAM 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3A illustrates operating system 334, application programs 335, other program modules 336, and program data 337.

The computer 310 may also include other removable/non-removable, volatile/nonvolatile computer storage media. By way of example only, FIG. 3A illustrates a hard disk drive 341 that reads from or writes to non-removable, nonvolatile magnetic media, a magnetic disk drive 351 that reads from or writes to a removable, nonvolatile magnetic disk 352, and an optical disc drive 355 that reads from or writes to a removable, nonvolatile optical disc 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disc drive 355 are typically connected to the system bus 321 by a removable memory interface, such as interface 350.

The drives and their associated computer storage media discussed above and illustrated in FIG. 3A, provide storage of computer readable instructions, data structures, program modules and other data for the computer 310. In FIG. 3A, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a digital camera 363, a keyboard 362, and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3A. The logical connections depicted in FIG. 3A include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3A illustrates remote application programs 385 as residing on memory device 381. It will be appreciated that the network connections shown are exemplary and other means of establishing a communications link between the computers may be used.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 3B or FIG. 3C. FIG. 3B illustrates an interface Interface1 as a conduit through which first and second code segments communicate. FIG. 3C illustrates an interface as comprising interface objects I1 and I2 (which may or may not be part of the first and second code segments), which enable first and second code segments of a system to communicate via medium M. In the view of FIG. 3C, one may consider interface objects I1 and I2 as separate interfaces of the same system and one may also consider that objects I1 and I2 plus medium M comprise the interface. Although FIGS. 3B and 3C show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 3B and 3C, but they nonetheless perform a similar function to accomplish the same overall result. We will now briefly describe some illustrative alternative implementations of a programming interface.

### A. Factoring

A communication from one code segment to another may be accomplished indirectly by breaking the communication into multiple discrete communications. This is depicted schematically in FIGS. 3D and 3E. As shown, some interfaces can be described in terms of divisible sets of functionality. Thus, the interface functionality of FIGS. 3B and 3C may be factored to achieve the same result, just as one may mathematically provide 24, or 2 times 2 times 3 times 2. Accordingly, as illustrated in FIG. 3D, the function provided by interface Interface1 may be subdivided to convert the communications of the interface into multiple interfaces Interface1A, Interface1B, Interface1C, etc. while achieving the same result. As illustrated in FIG. 3E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 3D and 3E, the functional spirit of interfaces Interface1 and I1 remain the same as with FIGS. 3B and 3C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

### B. Redefinition

In some cases, it may be possible to ignore, add or redefine certain aspects (e.g., parameters) of a programming interface while still accomplishing the intended result. This is illustrated in FIGS. 3F and 3G. For example, assume interface Interface1 of FIG. 3B includes a function call Square (input, precision, output), a call that includes three parameters, input, precision and output, and which is issued from the 1st Code Segment to the 2nd Code Segment. If the middle parameter precision is of no concern in a given scenario, as shown in FIG. 3F, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 3G, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, which are not needed for some purpose, and so they may be ignored or redefined, or processed elsewhere for other purposes.

### C. Inline Coding

It may also be feasible to merge some or all of the functionality of two separate code modules such that the “interface” between them changes form. For example, the functionality of FIGS. 3B and 3C may be converted to the functionality of FIGS. 3H and 3I, respectively. In FIG. 3H, the previous 1st and 2nd Code Segments of FIG. 3B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 3I, part (or all) of interface I2 from FIG. 3C may be written inline into interface I1 to form interface I1″. As illustrated, interface I2 is divided into I2a and I2b, and interface portion I2a has been coded in-line with interface I1 to form interface I1″. For a concrete example, consider that the interface I1 from FIG. 3C performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

### D. Divorce

A communication from one code segment to another may be accomplished indirectly by breaking the communication into multiple discrete communications. This is depicted schematically in FIGS. 3J and 3K. As shown in FIG. 3J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 3K, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 3C to a new operating system, while providing the same or similar functional result.

### E. Rewriting

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 3L and 3M. As can be seen in FIG. 3L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 3M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 3B and 3C. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

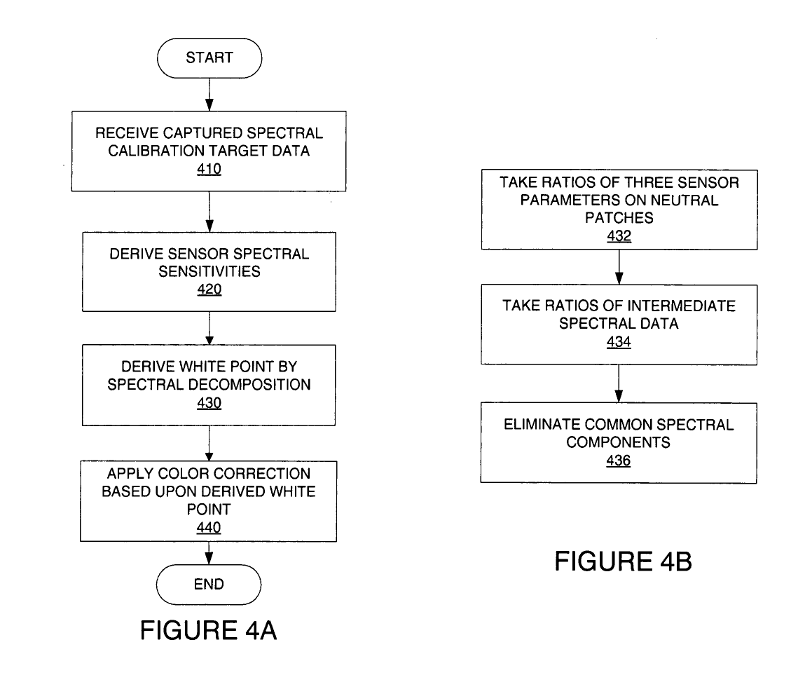

FIG. 4A shows a flowchart showing an illustrative embodiment of the steps to derive a white point for calibration and characterization of an image capturing device according to at least one aspect of the present invention, which can operate in conjunction with computer system environment 300 described in FIG. 3. At step 410, captured spectral calibration target data is received. Captured spectral calibration target data can be received from an image capturing device, such as a digital still camera. Spectral calibration target data may include a pre-existing spectral calibration target, such as defined in a standard by the International Electrotechnical Commission (IEC), IEC 61966-8.

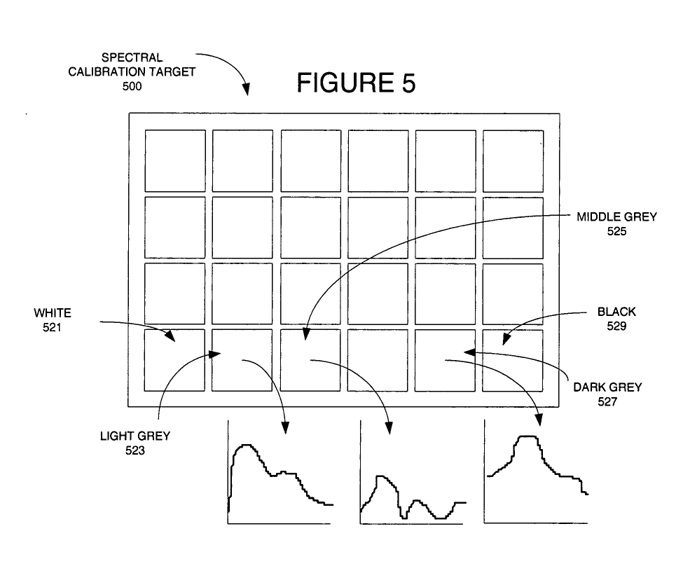

FIG. 5 illustrates a block diagram of an example of a spectral calibration target 500 and spectral responses. Spectral calibration target 500 may be the calibration target defined in standard IEC 61966-8 published in February 2001, which is herein incorporated by reference in its entirety. As shown in FIG. 5, spectral calibration target 500 is shown with twenty-four (24) different patches of representative colors, white, greys, and black. Spectral calibration target 500 is shown with a white sample 521, a light grey sample 523, a middle grey sample 525, a dark grey sample 527, and a black sample 529 specifically identified. Other samples, not identified, can include primary and secondary colorants, as well as additional greys. Specifically in FIG. 5, the spectral response of three samples are identified for light grey 523, middle grey 525, and dark grey 527. It should be understood by those skilled in the art that the example spectral calibration target 500 illustrated in FIG. 5 is but one example of a spectral calibration target.

Referring back to FIG. 4A, at step 420, sensor spectral sensitivities are derived. Alternatively, the sensor spectral sensitivities can be derived from information received directly from a manufacturer of the sensor and/or image capturing device, such as a digital still camera. Annex A of the IEC 61966-8 standard describes one method for deriving three (3) channel spectral sensitivities from a spectral target. The IEC 69166-8 standard is a multimedia color scanner standard with a spectral target. The standard specifically assumes being provided the spectral power distribution of a built-in light source as noted in the introduction of Annex B. The IEC 69199-8 standard requires a user to manually put white point information into the calculation; the standard does not enable or describe how to derive white point information, only how to derive sensor spectral sensitivities. Step 420 of FIG. 4A uses the spectral target and a digital camera to actually derive the spectral power distribution of the source. At step 430, the white point is derived by spectral decomposition from the spectral sensitivities derived using the methods in Annex A of IEC 69166-8 and spectral estimation methods known by those skilled in the art. Examples of spectral estimation methods are shown in P. D. Burns and R. S. Berns, “Analysis of Multispectral Image Capture”, Proc. of the IS&T/SID Fourth Color Imaging Conference Color Science, Systems, and Applications, IS&T, Springfield, Va., 1996, pp. 19-22 and F. H. Imai, “Multi-spectral Image Acquisition and Spectral Reconstruction Using a Trichromatic Digital Camera System Associated with Absorption Filters”, MCSL Technical Report, 1998. The IEC 61966-8 standard describes how to derive sensor spectral response and spectral estimation methods estimate the spectrum of a target given a multi-channel capture device.

Aspects of this invention utilize known spectral targets to derive the spectral sensitivities on the camera sensors and, with the white point target spectra and these derived sensitivities, to reconstruct or estimate the scene white point for conversion into an optimized white point in terms of camera channels. While spectral sensitivity estimation, spectral targets, spectral estimate, and even white point normalization are known in the art, aspects of this invention combine these features and optimize the target to provide a more accurate scene white point estimation. In accordance with one embodiment of the present invention, the target is optimized by including spectral samples which have spectral responses targeted to well known illuminant sources. For example, fluorescent sources are based on mercury emission and one can include various color targets that are near neutral in tungsten lighting but are very green in fluorescent lighting due to a target's very non-uniform spectral response. Similarly, targets that distinguish between tungsten and daylight or between different daylights may be created. In accordance with aspects of the present invention, these optimized targets help determine which common light source is in the scene. These spectral targets are carefully designed to optimize white point spectral estimation by having some of the targets with cutoffs near wavelengths that are maximally different between most common light sources such as warm and cool fluorescent lamps, tungsten lamps, sunlight, darn and dusk and overcast spectra. Most targets are not optimized to extract or determine white point. Most targets fall into one of two categories. The first type of target uses a limited set of primaries such as CMYK and thus is poor for spectral decomposition. The second type of target attempts to provide spectral responses of common objects like skin, grass, and sky. Neither of these types of targets is spectrally distinct in a manner to optimize the regression statistics to determine a white point.

At step 440, color correction is applied to all color data within the target based upon the derived white point. For example, in step 440, a user can input the color profile built from the derived white point into a color application program, such as Photoshop® by Adobe® Systems Incorporated of San Jose, Calif. A user can then operate the image capturing device, such as a digital still camera without having the device guess data values in weak and/or oversensitive areas of the sensor of the image capturing device. An application programming interface (API) can be accessed to initiate the color application program described above and/or an application program for determining the white point of an image capturing device based upon the steps illustrated above.

FIG. 4B shows a flowchart showing an illustrative embodiment of the step 430 to derive a white point for calibration of an image capturing device, such as a digital still camera, according to at least one aspect of the present invention. At step 432, the ratios of three sensor parameters based upon neutral patch samples of the spectral calibration target are taken. At step 434, the ratios of intermediate spectral data based upon the spectral calibration target are taken. It should be understood by those skilled in the art that the ratios of three sensor parameters are based on both neutral and highly chromatic samples. Having a sharp wavelength cutoff in one sample provides clean information on what spectra the sensor is sensitive to. It should further be understood that intermediate sensor spectral date is normalized spectral data that is optimized to either estimate the sensor sensitivities (see IEC 61966-8 standard) or optimized to estimate white point. Finally, at step 436, common spectral components of the ratios of sensor parameters and the ratios of intermediate spectral data are eliminated.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. Further, the examples illustrated in the Figures identify a digital camera. It should be understood by those skilled in the art that a digital camera is a type of an image capturing device and that the present invention is not so limited to a digital camera. It will also be appreciated and understood that modifications may be made without departing from the true spirit and scope of the present invention. The description is thus to be regarded as illustrative instead of restrictive on the present invention.

1. A method for determining white point data for calibration of an image capturing device, the method comprising steps of:
receiving captured spectral calibration target data;
obtaining sensor spectral sensitivities of the image capturing device; and
determining the white point data for calibration of the image capturing device based upon the received spectral calibration target data and the obtained sensor spectral sensitivities of the image capturing device.

2. The method of claim 1, wherein the captured spectral calibration target data complies with a standard defined by IEC 61966-8.

3. The method of claim 1, wherein the step of obtaining sensor spectral sensitivities of the image capturing device includes obtaining the sensor spectral sensitivities based on pre-existing data of the image capturing device.

4. The method of claim 3, wherein the pre-existing data is provided by a manufacturer of the image capturing device.

5. The method of claim 1, wherein the step of obtaining sensor spectral sensitivities of the image capturing device includes a step of automatically deriving the sensor spectral sensitivities.

6. The method of claim 5, wherein the step of automatically deriving the white point data includes steps of:
determining ratios of sensor parameters based upon neutral patch sample data of the received captured spectral calibration target data;
determining ratios of intermediate spectral data based upon the received captured spectral calibration target data; and
eliminating common spectral components of the determined ratios of sensor parameters and determined ratios of intermediate spectral data.

7. The method of claim 1, further comprising a step of applying color correction based upon the determined white point data.

8. The method of claim 7, wherein the step of applying color correction includes steps of:
building a profile based on the determined white point data for the image capturing device; and
adjusting data values in an image captured by the image capturing device according to the profile.

9. The method of claim 1, wherein the step of obtaining sensor spectral sensitivities of the image capturing device includes a step of estimating data values for regions between measurable parameter areas of the sensor of the image capturing device.

10. The method of claim 1, wherein the step of obtaining sensor spectral sensitivities of the image capturing device includes a step of estimating data values for regions of overlapped measurable parameter areas of the sensor of the image capturing device.

11. The method of claim 1, wherein the step of obtaining sensor spectral sensitivities of the image capturing device includes deriving sensor spectral sensitivities of the image capturing device by spectral decomposition.

12. The method of claim 1, wherein the step of determining the white point data for calibration of the image capturing device includes deriving the white point by spectral decomposition.

13. The method of claim 1, wherein the determined white point data applies to a plurality of lighting conditions.

14. The method of claim 1, wherein the step of determining the white point data includes a step of determining an estimate of a lighting condition of the received captured spectral calibration target data.

15. The method of claim 1, further comprising a step of calibrating the image capturing device based on the determined white point data.

16. The method of claim 1, wherein the step of determining the white point data includes automatically determining the white point data.

17. A system for determining a white point for calibration of an image capturing device, the system comprising:
an image capturing device configured to capture data associated with a spectral calibration target;
a processing component configured to receive captured spectral calibration target data, to obtain sensor sensitivities of the image capturing device, and to determine the white point.

18. The system of claim 17, wherein the spectral calibration target complies with a standard defined by IEC 61966-8.

19. The system of claim 17, wherein the processor is further configured to determine ratios of sensor parameters based upon captured neutral patch sample data of the spectral calibration target, to determine ratios of intermediate spectral data based upon the captured spectral calibration target data, and to eliminate common spectral components of the determined ratios of sensor parameters and the determined ratios of intermediate spectral data.

20. The system of claim 17, wherein the processing component is further configured to apply color correction based upon the determined white point.

21. The system of claim 20, wherein the processing component is further configured to build a profile based on the determined white point.

22. The system of claim 17, wherein the processing component obtains sensor sensitivities by spectral decomposition.

23. The system of claim 17, wherein the processing component determines the white point by spectral decomposition.

24. The system of claim 17, wherein the processing component is further configured to calibrate the image capturing device based on the determined white point.

25. The system of claim 17, wherein the processing component is configured to determine the white point automatically.

26. A computer-readable medium having computer-executable instructions for determining white point data for calibration of an image capturing device, the method comprising steps of:
receiving captured spectral calibration target data;
obtaining sensor spectral sensitivities of the image capturing device; and
determining the white point data for calibration of the image capturing device based upon the received spectral calibration target data and obtained sensor spectral sensitivities of the image capturing device.

27. The computer-readable medium of claim 26, further comprising steps of:
determining ratios of sensor parameters based upon neutral patch sample data of the received captured spectral calibration target data;
determining ratios of intermediate spectral data based upon received captured spectral calibration target data; and
eliminating common spectral components of the determined ratios of sensor parameters and the determined ratios of intermediate spectral data.

28. A software architecture for determining white point data for calibration of an image capturing device, comprising:
at least one component configured to receive captured spectral calibration target data, obtaining sensor spectral sensitivities, and determining the white point data; and
at least one application program interface to access the component.

29. The software architecture of claim 28, wherein the at least one application program interface is configured to access the at least one component responsive to a request.
